(19) United States
(12) Patent Application Publication
(10) Pub. No.: US 2026/0051936 A1
(43) Pub. Date: Feb. 19, 2026

(54) COHERENT JOINT TRANSMISSION CODEBOOK FOR LOCALIZED MULTI-TRANSMIT RECEIVE POINT MODE

(71) Applicant: QUALCOMM Incorporated, San Diego, CA (US)

(72) Inventors: Hyojin LEE, San Diego, CA (US); Jing DAI, Beijing (CN); Yu ZHANG, San Diego, CA (US); Lei XIAO, San Jose, CA (US)

(21) Appl. No.: 19/103,206

(22) PCT Filed: Sep. 30, 2022
(86) PCT No.: PCT/CN2022/123313

§ 371 Date: Feb. 11, 2025

(51) Int. Cl. H04B 7/06

(52) U.S. Cl. CPC H04B 7/0626; H04B 7/0639

(57) ABSTRACT

Aspects of the present disclosure provide techniques for utilizing coherent joint transmission (CJT) codebook for localized multi-TRP deployment that minimizes overhead requirements needed for reporting channel feedback information. To this end, the UEs may generate CSI report based on CJT codebook that indicates a common precoding index for a spatial domain matrix for TRPs that are physically co-located. In some examples, the UE may provide a precoding matrix that is based on combination of parameters such as spatial domain matrix, spanning coefficients, and frequency domain matrix. Each of the precoding matrix parameters may be stacked corresponding to the number of TRPs that are localized in physical co-location in order to minimize the amount of information that the UE may need to report.

### BACKGROUND

### Technical Field

The present disclosure relates generally to communication systems, and more particularly, to coherent joint transmission (CJT) codebook for localized multiple transmit receive point (multi-TRP) mode.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, methods, a non-transitory computer-readable mediums, and apparatuses are provided. The method may include receiving, at a user equipment (UE), a channel state information reference signal (CSI-RS) from a set of transmit receive points (TRPs) associated with a network entity, wherein at least a subset of TRPs from the set of TRPs are physically co-located. The method may further include generating a channel state information (CSI) report based on a coherent joint transmission (CJT) codebook that indicates a common precoding index for a spatial domain matrix for the subset of TRPs that are physically co-located. The method may further include transmitting the CSI report to the network entity.

In an aspect, the disclosure provides an apparatus for wireless communication. The apparatus may include a memory storing computer-executable instructions and a processor, communicatively coupled with the memory and configured to execute the instructions. The processor may be configured to receive, at a UE, a CSI-RS from a set of TRPs associated with a network entity, wherein at least a subset of TRPs from the set of TRPs are physically co-located. The processor may further be configured to generate a CSI report based on a CJT codebook that indicates a common precoding index for a spatial domain matrix for the subset of TRPs that are physically co-located. The processor may further be configured to transmit the CSI report to the network entity.

In another aspect, the disclosure provides an apparatus for wireless communication. The apparatus may include means for receiving, at a UE, a CSI-RS from a set of TRPs associated with a network entity, wherein at least a subset of TRPs from the set of TRPs are physically co-located. The apparatus may include means for generating a CSI report based on a CJT codebook that indicates a common precoding index for a spatial domain matrix for the subset of TRPs that are physically co-located. The apparatus may include means for transmitting the CSI report to the network entity.

In another aspect, the disclosure provides a non-transitory computer-readable medium storing computer executable code. The non-transitory computer-readable medium may include code to receive, at a UE, a CSI-RS from a set of TRPs associated with a network entity, wherein at least a subset of TRPs from the set of TRPs are physically co-located. The non-transitory computer-readable medium may further include code to generate a CSI report based on a CJT codebook that indicates a common precoding index for a spatial domain matrix for the subset of TRPs that are physically co-located. The non-transitory computer-readable medium may further include code to transmit the CSI report to the network entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a UL channels within a subframe.

FIG. 3 is a diagram illustrating an example of a base station and user equipment (UE) in an access network.

FIG. 4 is an example of call flow diagram between a network entity and UE for downlink adaptation based on CSI-RS in accordance with aspects of the present disclosure.

FIG. 5 is a schematic diagram illustrating an example configuration for deriving a precoding matrix in accordance with aspects of the present disclosure.

FIG. 6 is an example of a distributed multi-TRP scenario that includes multiple TRP cell for a UE in accordance with various aspects of the present disclosure.

FIG. 7 is an example of a localized multi-TRP deployment of a plurality of TRPs that are physically co-located in accordance with various aspects of the present disclosure.

FIG. 8 is an schematic diagram of example deployment of plurality of TRPs where the set of TRPs may be subdivided into a plurality of TRP groups in accordance with various aspects of the present disclosure.

FIG. 9 is another diagram of localized TRP deployment with plurality of TRPs that are subdivided into TRP groups in accordance with various aspects of the present disclosure.

FIG. 10 is a flowchart of an example method of wireless communication according to aspects of the present disclosure.

FIG. 11 is a schematic diagram of example components of the UE of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

To meet the growing demands for expanded mobile broadband connectivity, wireless communication technologies are being adapted to support communication with multiple users sharing the available system resources. One such development has focused on multi-TRP techniques to improve link reliability and throughput. The network may include multiple TRPs deployed at various geographical locations (e.g., on different buildings). The TRPs may be communicatively coupled to multiple or single network entity. The TRPs may also be associated with one or more cells. For multi-TRP transmissions, the network may form clusters of TRPs to serve UEs. For example, one or more network entities may coordinate with each other to schedule a cluster of TRPs to serve a downlink transmission to a UE. The dynamic behaviors of radio conditions, spectrum utilization, and/or traffic loading, and/or UE-mobility can, however, cause various challenges for multi-TRP-based communications.

For example, the distributed TRP deployment where different TRPs are located in geometrically distributed manner (e.g., a first TRP located on one building and second TRP located on another building) requires extensive feedback overhead. The feedback overhead increases proportional to the number of TRPs (N) that are deployed because each TRP may be spatially distanced from the other TRPs and have different delay profiles for the beams. Thus, providing channel state information (CSI) for multi-TRPs that are deployed in distributed manner may require the UE to provide extensive amount of information. And if multiple TRPs are uncalibrated with respect to carrier frequency or sampling clock timing, coherent transmission between TRPs may be unfeasible since intercarrier interference (ICI) may be introduced.

Aspects of the present disclosure provide techniques for utilizing coherent joint transmission (CJT) codebook for localized multi-TRP deployment that minimizes overhead requirements needed for reporting channel feedback information. To this end, the UEs may generate CSI report based on CJT codebook that indicates a common precoding index for a spatial domain matrix for TRPs that are physically co-located. In some examples, the UE may provide a precoding matrix that is based on combination of parameters such as spatial domain matrix, spanning coefficients, and frequency domain matrix. Each of the precoding matrix parameters may be stacked corresponding to the number of TRPs that are localized in physical co-location in order to minimize the amount of information that the UE may need to report.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

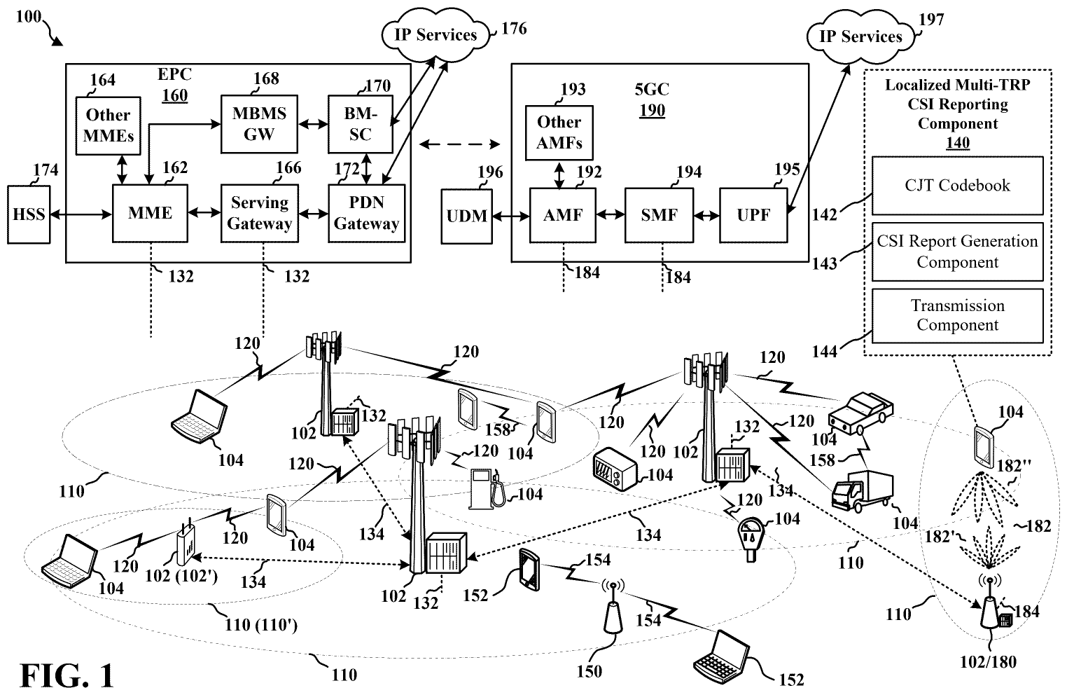

FIG. 1 is a diagram illustrating an example of a wireless communications system and an access network 100 in which limits for blind decoding of a search space are implemented. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells.

In an aspect, one or more of the UEs 104 may include a localized multi-TRP CSI reporting component 140 for receiving, at a user equipment (UE), a channel state information reference signal (CSI-RS) from a set of transmit receive points (TRPs) associated with a network entity, wherein at least a subset of TRPs from the set of TRPs may be physically co-located. Based on the received CSI-RS, the localized multi-TRP CSI reporting component 140 may generating a CSI report. The UE 104, and more particularly the localized multi-TRP CSI reporting component 140 may generate the CSI report, in response to the CSI-RS, based on a CJT codebook 142 that indicates a common precoding index for a spatial domain matrix for the subset of TRPs that are physically co-located. In some examples, the localized multi-TRP CSI reporting component 140 may leverage the CSI report generation component 143 for generating the CSI report. The localized multi-TRP CSI reporting component 140 and/or the transmission component may then transmit the CSI report to the network entity.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

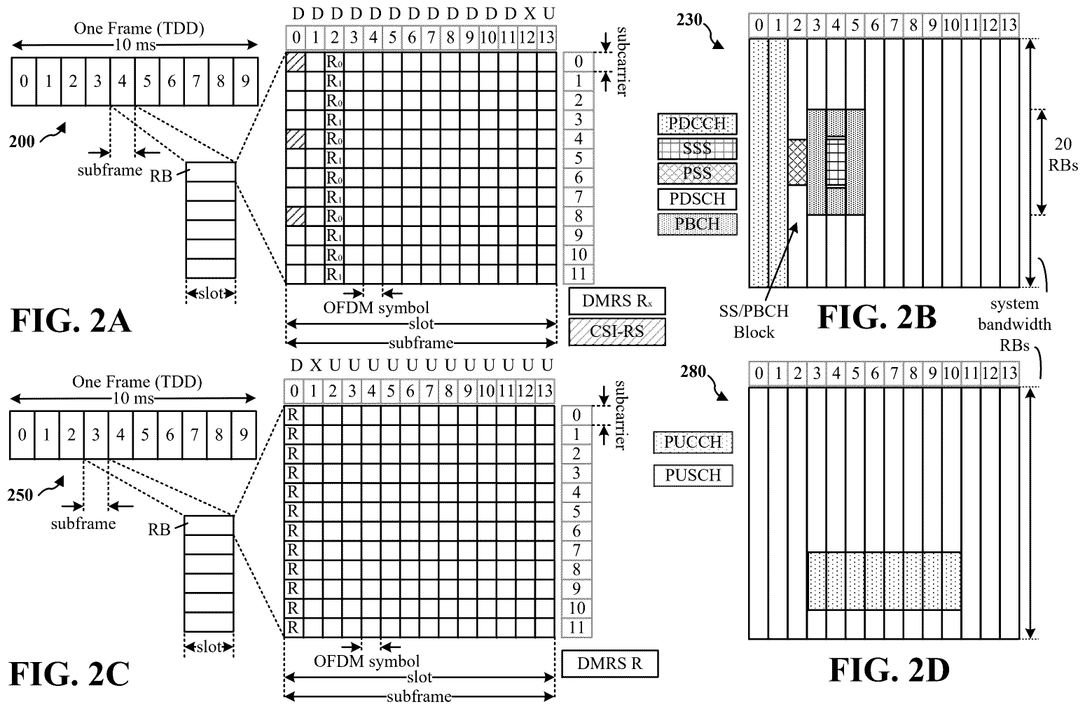

FIGS. 2A-2D are resource diagrams illustrating example frame structures and resources that may be used by communications between the UE 104 and the base station 102 of FIG. 1. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}*15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

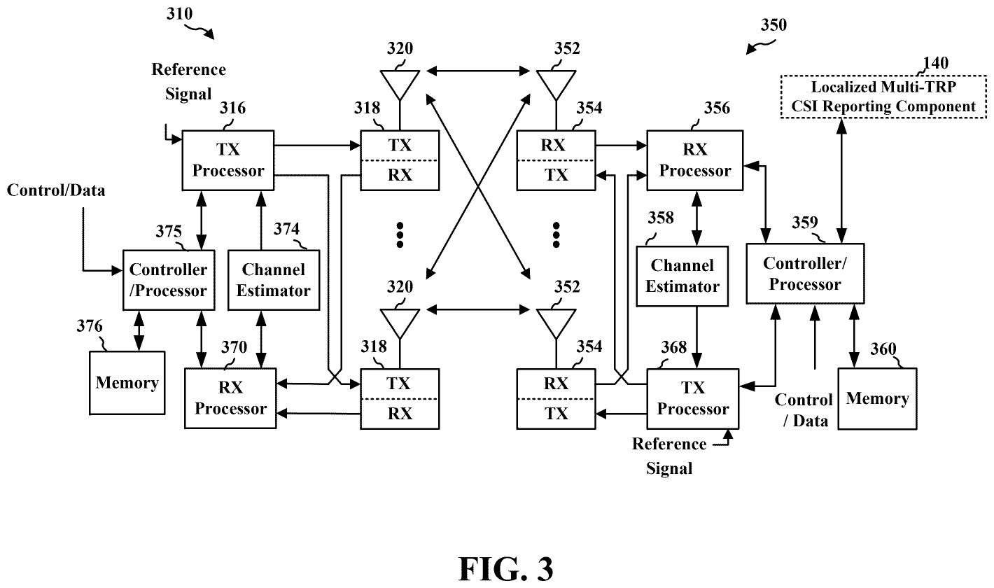

FIG. 3 is a diagram of a base station 310 in communication with a UE 350. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the localized multi-TRP CSI reporting component 140 of FIG. 1.

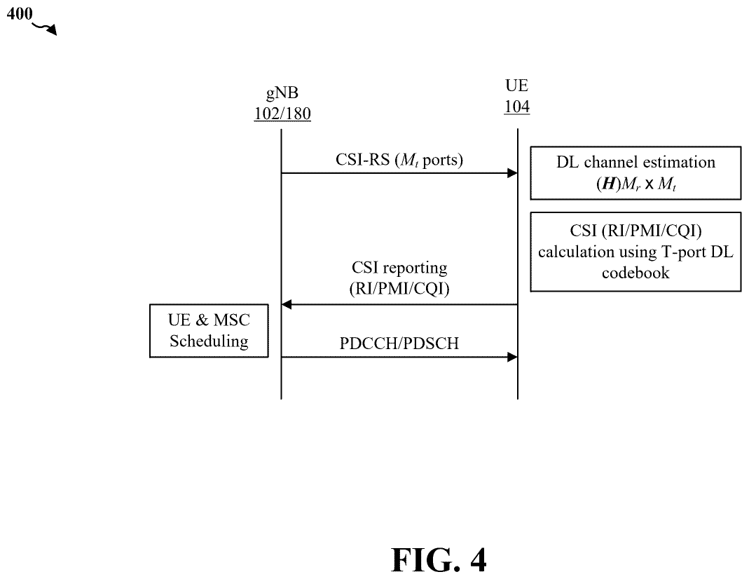

FIG. 4 is an example of call flow diagram 400 between a gNB (102/180) and UE 104 for downlink adaptation based on CSI-RS in order to improve signal reliability and throughput. In some examples, each cell may include one or more TRPs, each transmitting on different beams. To this end, the network entity (e.g., gNB 102/180) may transmit CSI-RS 405 to the UE. In response, the UE 104 may perform downlink channel estimation, where the Mᵣ×Mₜ downlink channel matrix H may be estimated based on Mₜ port CSI based on following equation:

$$H = [ \begin{matrix}{h}_{1 , 1} & … & {h}_{1 , {M}_{t}} \\ ⋮ & ⋱ & ⋮ \\ {h}_{{M}_{r}} , 1 & … & {h}_{{M}_{r}} , {M}_{t}\end{matrix} ] \qquad Equation 1.$$

The CSI feedback may include several parameters, such as rank indicator (RI), precoding matrix indicator (PMI), and channel quality indicator (CQI). The downlink channel matrix H may be a function of RI and precoding matrix index, and may be included in CQI calculations. The UE 104 may use the channel state information reference signal (CSI-RS) to measure the CSI feedback. Upon receiving the CSI parameters, the gNB may schedule downlink data transmissions (such as modulation scheme, code rate, number of transmission layers, and MIMO precoding) accordingly.

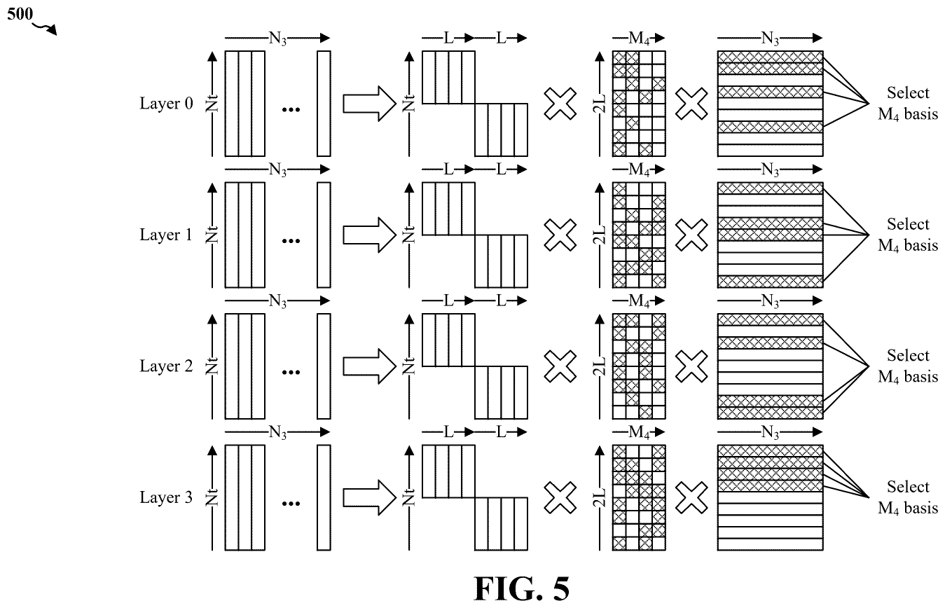

FIG. 5 is a schematic diagram 500 illustrating an example configuration for deriving a precoding matrix (W). The precoding matrix for the CSI report may be calculated based on the following equation for a single TRP:

$$W = {W}_{1} \times {\tilde{W}}_{2} \times {W}_{f}^{H} \qquad Equation 2.$$

As illustrated in diagram 500, the precoding matrix (W) may be a function of spatial domain (SD) bases (W₁), a spanning coefficient (\tilde{W}₂), and frequency domain (FD) bases matrix

$$( {W}_{f}^{H} ) .$$

And where there is multiple distributed TRPs deployed, the precoding matrix (W) may be calculated by stacking the SD bases (W₁), a spanning coefficient (\tilde{W}₂), and FD bases matrix

$$( {W}_{f}^{H} )$$

for each of the plurality of TRPs.

Particularly the codebook for CJT for multi-TRP may support two modes. In the first mode (Mode 1), the per-TRP/TRP-Group SD/FD basis selection may allow independent FD basis selection across N number of TRPs/TRP groups. An example formulation (N=number of TRPs or TRP groups) may be derived as follow:

$$[ \begin{matrix}{W}_{1 , 1} & {\tilde{W}}_{2 , 1} & {W}_{f , 1}^{H} \\ & ⋮ & \\ {W}_{1 , N} & {\tilde{W}}_{2 , N} & {W}_{f , N}^{H}\end{matrix} ] \qquad Equation 3.$$

In the second mode (Mode 2), SD basis selection and common/joint (across N TRPs) FD basis selection may be implemented. An example formulation for the second mode may be:

$$[ \begin{matrix}{W}_{1 , 1} & {\tilde{W}}_{2 , 1} & {W}_{f}^{H} \\ & ⋮ & \\ {W}_{1 , N} & {\tilde{W}}_{2 , N} & {W}_{f}^{H}\end{matrix} ] \qquad Equation 4.$$

The above discussed CJT codebook modes assumes that for each of TRPs, a separate spatial basis (e.g., W_{1,1}, . . . W_{1,N}), separate coefficients (\tilde{W}_{2,1}, . . . \tilde{W}_{2,N}), and separate (or common) frequency basis

$$( {W}_{f , 1}^{H} … {W}_{f , N}^{H} )$$

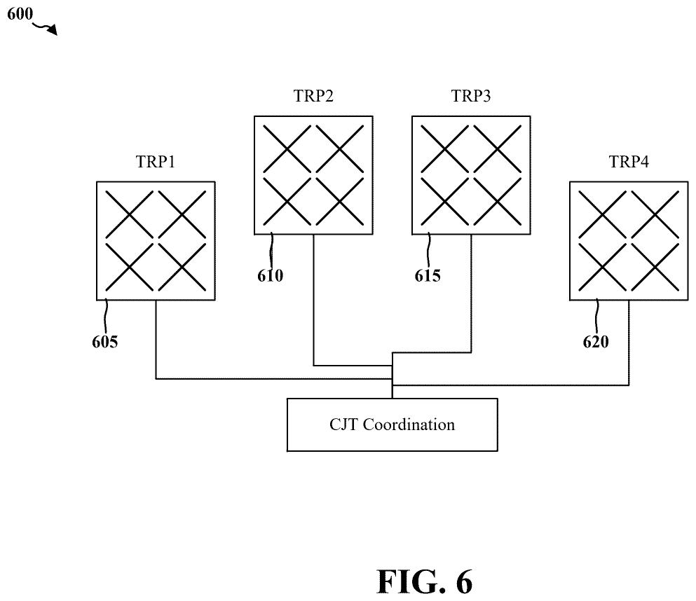

may be selected by the UE for CSI feedback. Reporting each of the separate SD basis, coefficient basis, and FD basis, however, increases overhead. This is because the above configuration may be suited for distributed TRP scenario where different TRPs are located in a geometrically distributed manner. FIG. 6 is an example of a distributed multi-TRP scenario 600 that includes a multi-TRP cell for a UE 104. In such instance, the first TRP 605 may be physically located at a separate location (e.g., different building) from second TRP 610. Similarly, the third TRP 615 and fourth TRP 620 are all located in different physical locations from each TRP. In such instance, providing CSI feedback for each of the distributed TRPs with separate spatial basis (e.g., W_{1,1}, . . . W_{1,N}), separate coefficients (\tilde{W}_{2,1}, . . . \tilde{W}_{2,N}), and separate (or common) frequency basis

$$( {W}_{f , 1}^{H} … {W}_{f , N}^{H} )$$

increases overhead that is proportional to the number (N) of the TRPs. And even in case of common frequency basis, the number of basis vectors may be increased to cover different delays for different TRPs.

If multiple TRPs are uncalibrated with respect to carrier frequency or sampling clock timing, coherent transmission between TRPs may be unfeasible since ICI may be introduced, which limits the benefit of CJT. Thus, a CJT in distributed TRP scenario may be challenging because TRPs would need to have tight calibration between different TRPs. But even if tight calibration between a plurality of distributed TRPs is conducted, UE mobility may provide a different doppler shifts for different TRPs which may lead to frequency offset between the TRPs.

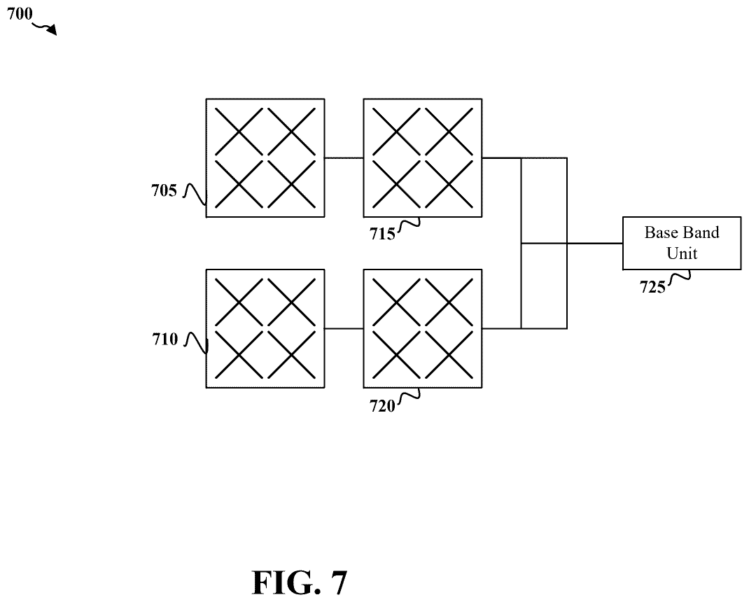

FIG. 7 is an example of a localized multi-TRP deployment 700 that may include a first TRP 705, second TRP 710, third TRP 715, and fourth TRP 720 that may be co-located in the same physical location (e.g., all four on the roof of the same building). Although four TRPs are illustrated, it should be appreciated by those of ordinary skill in the art that the number of TRPs can be less or more within the same co-location, so long as there are plurality of TRPs within the same location. In some examples, the plurality of TRPs may be connected with a single base band (BB) unit 725. In other examples, different TRPs may be connected to different BB unit that may include a first cluster of TRPs connected to a first BB unit and a second cluster of TRPs connected to a second BB unit. In other examples, each TRP may be connected to a different BB unit. However, where the plurality of TRPs are co-located and connected to the single BB unit 725, the system performance may be improved as a single BB unit may be able to tightly calibrate the plurality of TRPs.

In accordance with aspects of the present disclosure, the CJT may also provide benefits for localized multi-TRPs because using multiple TRPs (panels) having the same boresight direction instead of fitting all the antenna elements into a single calibrated panel may decrease the implementation complexity. And multi-panel arrays may be more suitable for massive MIMO gNBs. CJT between localized TRP may also provide practical benefits than distributed case since the co-location of the TRPs affords tight calibration between different TRPs (or panels) in localized case. Additionally, the same doppler shifts for different TRPs may be realized on the UE side.

Thus, the techniques disclosed here allow the UE to be configured with a specific eType-II CJT codebook mode which is designed to support multi-TRP (panel) scenario. When the UE is configured with eType-II CJT codebook for localized multi-TRP, one or more of the following codebook structures may be used to derive and report the PMI.

In first example of a codebook structure, a common or same spatial basis for multi-TRP may be selected for each TRP as shown below (W₁ is the common value for each row that represents different TRPs):

$$[ \begin{matrix}{W}_{1} & {\tilde{W}}_{2 , 1} & {W}_{f}^{H} \\ & ⋮ & \\ {W}_{1} & {\tilde{W}}_{2 , N} & {W}_{f}^{H}\end{matrix} ] \qquad Equation 5.$$

Because the distance between co-located TRPs (panels) may be negligible compared to the distance between the network entity and the UE, the spatial direction per panel for a single UE may not be significantly different. As such, the UE may report a common (or same) precoding index for a spatial domain matrix (W₁) for the subset of TRPs that are physically co-located. And information on the common frequency basis (W_{f}) for different TRPs may also be reported in the first codebook structure.

In one example of the first codebook structure, the phases and amplitudes of coefficients (\tilde{W}_{2,1}, . . . , \tilde{W}_{2,N}) may be different for each TRP that is reported, as shown in Equation 5.0 above. But even with different coefficient basis for the different TRPs, such structure still provides efficiency that exceeds the distributed TRP scenario because, in such localized scenario, a smaller number of frequency basis vectors may be needed than distributed TRP scenario since the delay profiles for different TRPs that are co-located would be similar to each other.

In a second codebook structure example, a common precoding index for a spatial domain matrix (e.g., W₁), coefficient (\tilde{W}₂,), and frequency basis

$$( {W}_{f}^{H} )$$

may be selected by the UE for all three parameters for each of the different TRPs as shown below:

$$[ \begin{matrix}{W}_{1} & {\tilde{W}}_{2} & {W}_{f}^{H} \\ {W}_{1} & {∅}_{2} {\tilde{W}}_{2} & {W}_{f}^{H} \\ & ⋮ & \\ {W}_{1} & {∅}_{N} {\tilde{W}}_{2} & {W}_{f}^{H}\end{matrix} ] = [ \begin{matrix}{W}_{1} & {\tilde{W}}_{2} & {W}_{f}^{H} \\ {∅}_{2} {W}_{1} & {\tilde{W}}_{2} & {W}_{f}^{H} \\ & ⋮ & \\ {∅}_{N} {W}_{1} & {\tilde{W}}_{2} & {W}_{f}^{H}\end{matrix} ] \qquad Equation 6.$$

In such instance, the spatial direction per TRP as well as propagation delay per panel for a single UE may not be so different for each of the TRPs that are co-located. Thus, the sample spatial and frequency basis, as well as the same coefficients for different TRPs may be selected.

But to allow flexible inter-TRP distance, a phase-offset between different TRPs (panels) may be included by introducing co-phasing values for different TRPs. Thus, in such instance, the precoding index for W₁ may be common for all TPRs that the UE reports to the network entity. Additionally, a common frequency basis (W_{f}) and coefficients \tilde{W}₂ for different TRPs may also be reported to the network entity as part of the CSI report. However, to account for the phase-offset, additional co-phasing values between different TRPs may be reported. Thus, as shown above, the co-phasing values (Ø₂, . . . , Ø_{N}) could be within a given alphabet (e.g. QPSK or 8PSK) that are included as part of equation 6.0.

In another codebook structure example, a common spatial basis (W₁), frequency basis (W_{f}), and coefficients (W₂) for multi-TRP may be selected and reported by the UE for the plurality of TRPs. But, additionally or alternatively, the third codebook structure may also include different co-phasing values for different polarities (POLs) to account for the different antennas within each TRP:

$$[ \begin{matrix}{W}_{1} {\tilde{W}}_{2} {W}_{f}^{H} \\ \begin{matrix}{W}_{1} & [ \begin{matrix}{∅}_{2}^{pol 1} {I}_{L} & {0}_{L} \\ {0}_{L} & {∅}_{2}^{pol 2} {I}_{L}\end{matrix} ] & {\tilde{W}}_{2} {W}_{f}^{H}\end{matrix} \\ ⋮ \\ \begin{matrix}{W}_{1} & [ \begin{matrix}{∅}_{2}^{pol 1} {I}_{L} & {0}_{L} \\ {0}_{L} & {∅}_{2}^{pol 2} {I}_{L}\end{matrix} ] & {\tilde{W}}_{2} {W}_{f}^{H}\end{matrix}\end{matrix} ] \qquad Equation 7.$$

$${I}_{L} : L \times L identtity matrix ,$$

$${0}_{L} : L \times L zero matrix$$

Thus, in such instance, the precoding index for W₁ may be common for all TPRs that are physically co-located that the UE reports to the network entity. Additionally, a common frequency basis (W_{f}) and coefficients \tilde{W}₂ for different TRPs that are co-located may also be reported to the network entity as part of the CSI report. However, in such example, a per-POL co-phasing values between different TRPs may be reported

$$( {∅}_{2}^{pol 1} , … , {∅}_{N}^{pol 1} and {∅}_{2}^{pol 2} , … , {∅}_{N}^{pol 2} )$$

that are given alphabet (e.g., QPSK or 8PSK).

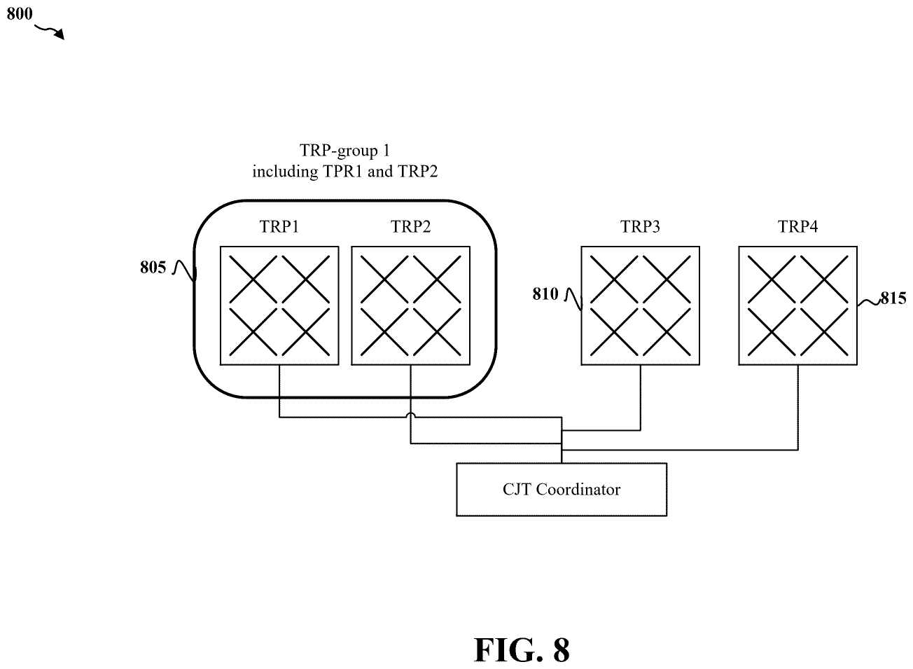

FIG. 8 is a schematic diagram 800 of example deployment of plurality of TRPs where the set of TRPs may be subdivided into a plurality of TRP groups, and each TRP group from the plurality of TRP groups may include one or more TRPs that are physically co-located. For example, a first TRP and second TRP may be included as part of a first TRP group 805, whereas the third TRP may be included as part of a second TRP group 810, and a fourth TRP may be included in a third TRP group 815. Thus, in such scenario, the TRPs may be deployed with two co-located TRPs, and two single TRPs that may be part of a separate group.

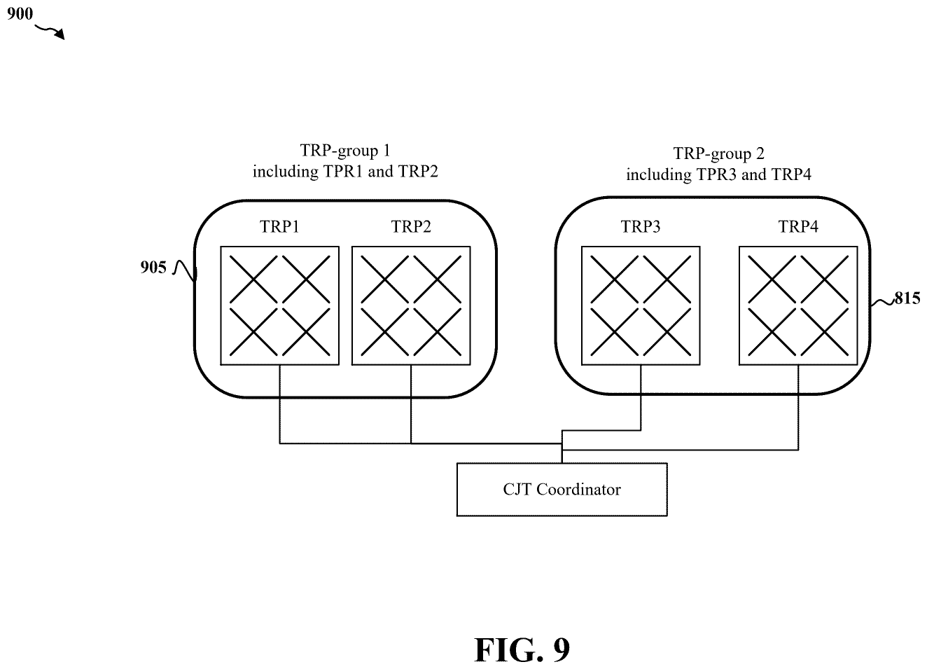

FIG. 9 is another diagram 900 configuration of a plurality TRPs that are grouped together. In such scenario, the first and second TRPs may be grouped as part of the first TRP group, while third and fourth TRPs may be grouped as part of the second TRP group. Thus, a person of ordinary skill may appreciate that the plurality of TRPs may be grouped in any number of configurations, including where all the TRPs are part of the same group as they are co-located, or where a subset of TRPs (e.g., three TRPs that are co-located), but one TRP is not physically co-located, and therefore is configured as a standalone group.

But in each instance of subdividing the plurality of TRPs into a plurality of groups as shown in FIGS. 8 and 9, the UE may be configured with information on TRP (or CSI-RS resource) grouping, where ach TRP-group (or CSI-RS resource group) may compose of co-located TRPs (CSI-RS resources).

Thus, if the UE is configured with TRP (CSI-RS resource) grouping information, the corresponding CJT codebook structure may be used to derive and report the PMI. In one example, a common precoding index for spatial domain matrix (W₁) and the frequency basis (W_{f}) may be selected for each TRP group, whereas the coefficients \tilde{W}₂ may be different for each TRP. For example, the plurality of TRP groups may include a first TRP group comprising a plurality of TRPs and a second TRP group including at least one TRP. The first TRP group may have a first precoding index for spatial domain matrix (W_{1,1}) that is common for all of the plurality of TRPs within the first TRP group, and the second TRP group may have a second precoding index for spatial domain matrix (W_{1,2}) that is common for all TRPs within the second TRP group. But the first precoding index for spatial domain matrix (W_{1,1}) and the second precoding index for spatial domain matrix (W_{1,2}) may be different. In such scenario, the set of TRPs for both the first TRP group and the second TRP group may include a different coefficient matrix (\tilde{W}_{2,1} . . . \tilde{W}_{2,N}). And because the frequency basis may be based on per-TRP grouping, the first TRP group may have a first frequency basis matrix (W_{f,1}) that is common for all of the plurality of TRPs within the first TRP group. The second TRP group may have a second frequency basis matrix (W_{f,2}) that is common for all of the plurality of TRPs within the second TRP group, the first frequency basis matrix and the second frequency basis matrix may be different.

As an example, a CJT between four (4) TRPs, when the first TRP group has three (3) co-located TRPs, and second TRP group has a single TRP configured, the following codebook structures may be used to derive and report the PMI:

$$[ \begin{matrix}{W}_{1 , 1} & {\tilde{W}}_{2 , 1} & {W}_{f , 1}^{H} \\ {W}_{1 , 1} & {\tilde{W}}_{2 , 2} & {W}_{f , 1}^{H} \\ {W}_{1 , 1} & {\tilde{W}}_{2 , 3} & {W}_{f , 1}^{H} \\ {W}_{1 , 2} & {\tilde{W}}_{2 , 4} & {W}_{f , 2}^{H}\end{matrix} ] or [ \begin{matrix}{W}_{1 , 1} & {\tilde{W}}_{2 , 1} & {W}_{f}^{H} \\ {W}_{1 , 1} & {\tilde{W}}_{2 , 2} & {W}_{f}^{H} \\ {W}_{1 , 1} & {\tilde{W}}_{2 , 3} & {W}_{f}^{H} \\ {W}_{1 , 2} & {\tilde{W}}_{2 , 4} & {W}_{f}^{H}\end{matrix} ] \qquad Equation 8.$$

And for the TRP grouping between four TRPs, when the first TRP group has two co-located TRPs and the second TRP group has another two co-located TRPs configuration, the following codebook structures may be used to derive and report the PMI:

$$[ \begin{matrix}{W}_{1 , 1} & {\tilde{W}}_{2 , 1} & {W}_{f , 1}^{H} \\ {W}_{1 , 1} & {\tilde{W}}_{2 , 2} & {W}_{f , 1}^{H} \\ {W}_{1 , 2} & {\tilde{W}}_{2 , 3} & {W}_{f , 2}^{H} \\ {W}_{1 , 2} & {\tilde{W}}_{2 , 4} & {W}_{f , 2}^{H}\end{matrix} ] or [ \begin{matrix}{W}_{1 , 1} & {\tilde{W}}_{2 , 1} & {W}_{f}^{H} \\ {W}_{1 , 1} & {\tilde{W}}_{2 , 2} & {W}_{f}^{H} \\ {W}_{1 , 1} & {\tilde{W}}_{2 , 3} & {W}_{f}^{H} \\ {W}_{1 , 2} & {\tilde{W}}_{2 , 4} & {W}_{f}^{H}\end{matrix} ] \qquad Equation 9.$$

For CJT between four TRPs that are subdivided into three groups, where first TRP group has two co-located TRPs, a second TRP group has a single TRP, and third TRP group has another single TRP configured, the following codebook structures may be used to derive and report the PMI:

$$[ \begin{matrix}{W}_{1 , 1} & {\tilde{W}}_{2 , 1} & {W}_{f , 1}^{H} \\ {W}_{1 , 1} & {\tilde{W}}_{2 , 2} & {W}_{f , 1}^{H} \\ {W}_{1 , 2} & {\tilde{W}}_{2 , 3} & {W}_{f , 2}^{H} \\ {W}_{1 , 3} & {\tilde{W}}_{2 , 4} & {W}_{f , 3}^{H}\end{matrix} ] or [ \begin{matrix}{W}_{1 , 1} & {\tilde{W}}_{2 , 1} & {W}_{f}^{H} \\ {W}_{1 , 1} & {\tilde{W}}_{2 , 2} & {W}_{f}^{H} \\ {W}_{1 , 2} & {\tilde{W}}_{2 , 3} & {W}_{f}^{H} \\ {W}_{1 , 3} & {\tilde{W}}_{2 , 4} & {W}_{f}^{H}\end{matrix} ] \qquad Equation 10.$$

For CJT between three TRPs, when first TRP group includes two co-located TRPs and second TRP group includes a single TRP configured, the following codebook structure may be used to derive and report the PMI:

$$[ \begin{matrix}{W}_{1 , 1} & {\tilde{W}}_{2 , 1} & {W}_{f , 1}^{H} \\ {W}_{1 , 1} & {\tilde{W}}_{2 , 2} & {W}_{f , 1}^{H} \\ {W}_{1 , 2} & {\tilde{W}}_{2 , 3} & {W}_{f , 2}^{H}\end{matrix} ] or [ \begin{matrix}{W}_{1 , 1} & {\tilde{W}}_{2 , 1} & {W}_{f}^{H} \\ {W}_{1 , 1} & {\tilde{W}}_{2 , 2} & {W}_{f}^{H} \\ {W}_{1 , 2} & {\tilde{W}}_{2 , 3} & {W}_{f}^{H}\end{matrix} ] \qquad Equation 11.$$

In sum, in some aspects, the UE may derive and report precoding information on spatial basis matrix on a per TRP group basis, phases and amplitudes of separate coefficients for different TRPs, and information on the common frequency basis for all TRPs or on frequency basis per TRP group.

In other scenarios, co-phasing (Ø) information may also be included within each group, where the UE may derive and report precoding information on spatial basis matrix, phases and amplitudes of coefficients, and frequency that are common for each TRP group. In such instance, when a first group has three co-located TRPs for example, and a second group has a single TRP that is configured, the following codebook structure may be used to derive and report the PMI:

$$[ \begin{matrix}{W}_{1 , 1} & {\tilde{W}}_{2 , 1} & {W}_{f , 1}^{H} \\ {∅}_{1 , 2} {W}_{1 , 1} & {\tilde{W}}_{2 , 1} & {W}_{f , 1}^{H} \\ {∅}_{1 , 3} {W}_{1 , 1} & {\tilde{W}}_{2 , 1} & {W}_{f , 1}^{H} \\ {W}_{1 , 2} & {\tilde{W}}_{2 , 2} & {W}_{f , 2}^{H}\end{matrix} ] or [ \begin{matrix}{W}_{1 , 1} & {\tilde{W}}_{2 , 1} & {W}_{f}^{H} \\ {∅}_{1 , 2} {W}_{1 , 1} & {\tilde{W}}_{2 , 1} & {W}_{f}^{H} \\ {∅}_{1 , 3} {W}_{1 , 1} & {\tilde{W}}_{2 , 1} & {W}_{f}^{H} \\ {W}_{1 , 2} & {\tilde{W}}_{2 , 2} & {W}_{f}^{H}\end{matrix} ] \qquad Equation 12.$$

And when a first TRP group may include two co-located TRPs and a second TRP group may include other two co-located TRPs, the following codebook structure may be used to derive and report PMI:

$$[ \begin{matrix}{W}_{1 , 1} & {\tilde{W}}_{2 , 1} & {W}_{f , 1}^{H} \\ {∅}_{1 , 2} {W}_{1 , 1} & {\tilde{W}}_{2 , 1} & {W}_{f , 1}^{H} \\ {W}_{1 , 2} & {\tilde{W}}_{2 , 2} & {W}_{f , 2}^{H} \\ {∅}_{2 , 2} {W}_{1 , 2} & {\tilde{W}}_{2 , 2} & {W}_{f , 2}^{H}\end{matrix} ] or [ \begin{matrix}{W}_{1 , 1} & {\tilde{W}}_{2 , 1} & {W}_{f}^{H} \\ {∅}_{1 , 2} {W}_{1 , 1} & {\tilde{W}}_{2 , 1} & {W}_{f}^{H} \\ {W}_{1 , 2} & {\tilde{W}}_{2 , 2} & {W}_{f}^{H} \\ {∅}_{2 , 2} {W}_{1 , 2} & {\tilde{W}}_{2 , 2} & {W}_{f}^{H}\end{matrix} ] \qquad Equation 13.$$

In another example where the first TRP group has two co-located TRPs, and second TRP group has a single TRP, and a third TRP group includes another single TRP, the following codebook structure may be used to derive and report PMI:

$$[ \begin{matrix}{W}_{1 , 1} & {\tilde{W}}_{2 , 1} & {W}_{f , 1}^{H} \\ {∅}_{1 , 2} {W}_{1 , 1} & {\tilde{W}}_{2 , 1} & {W}_{f , 1}^{H} \\ {W}_{1 , 2} & {\tilde{W}}_{2 , 2} & {W}_{f , 2}^{H} \\ {W}_{1 , 2} & {\tilde{W}}_{2 , 3} & {W}_{f , 3}^{H}\end{matrix} ] or [ \begin{matrix}{W}_{1 , 1} & {\tilde{W}}_{2 , 1} & {W}_{f}^{H} \\ {∅}_{1 , 2} {W}_{1 , 1} & {\tilde{W}}_{2 , 1} & {W}_{f}^{H} \\ {W}_{1 , 2} & {\tilde{W}}_{2 , 2} & {W}_{f}^{H} \\ {W}_{1 , 3} & {\tilde{W}}_{2 , 3} & {W}_{f}^{H}\end{matrix} ] \qquad Equation 14.$$

In a scenario between three TRPs, when first group includes two co-located TRPs and a second group includes a single TRP, the following codebook structure may be used to derive and report the PMI:

$$[ \begin{matrix}{W}_{1 , 1} & {\tilde{W}}_{2 , 1} & {W}_{f , 1}^{H} \\ {∅}_{1 , 2} {W}_{1 , 1} & {\tilde{W}}_{2 , 1} & {W}_{f , 1}^{H} \\ {W}_{1 , 2} & {\tilde{W}}_{2 , 2} & {W}_{f , 2}^{H}\end{matrix} ] or [ \begin{matrix}{W}_{1 , 1} & {\tilde{W}}_{2 , 1} & {W}_{f}^{H} \\ {∅}_{1 , 2} {W}_{1 , 1} & {\tilde{W}}_{2 , 1} & {W}_{f}^{H} \\ {W}_{1 , 2} & {\tilde{W}}_{2 , 2} & {W}_{f}^{H}\end{matrix} ] \qquad Equation 15.$$

In sum, for such scenario, the UE may derive and report a precoding information on spatial basis on a per TRP group. Information on frequency basis that is also per TRP group (or a single frequency basis for all TRPs) and coefficients that are on per TRP-group basis may also be derived and reported by the UE to the network entity. Additionally, co-phasing values between different TRPs per TRP group (Ø_{g,2}, . . . , Ø_{g,N}) could be given alphabet (e.g., QPSK or 8PSK), where g is the group index and N is the number of TRPs in the group.

In yet another example, the UE may derive and report per-TRP-group W₁, per-TRP \tilde{W}₂, and shared or per-TRP-group W_{f} per-POL co-phasing Ø within group. In such instance, for CIT between 4 TRPs, when first group includes three (3) co-located TRPs and a second TRP group includes a single TRP, the following codebook structure is used to derive/report PMI:

$$[ \begin{matrix}{W}_{1 , 1} {\tilde{W}}_{2 , 1} {W}_{f , 1}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f , 1}^{H}\end{matrix} \\ \begin{matrix}{W}_{1 , 1} & [ \begin{matrix}{∅}_{1 , 2}^{pol 1} {I}_{L} & {0}_{L} \\ {0}_{L} & {∅}_{1 , 3}^{pol 2} {I}_{L}\end{matrix} ] & {\tilde{W}}_{2 , 1} {W}_{f , 1}^{H}\end{matrix} \\ {W}_{1 , 2} {\tilde{W}}_{2 , 2} {W}_{f , 2}^{H}\end{matrix} ] or \qquad Equation 16.$$

$$[ \begin{matrix}{W}_{1 , 1} {\tilde{W}}_{2 , 1} {W}_{f}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f}^{H}\end{matrix} \\ \begin{matrix}{W}_{1 , 1} & [ \begin{matrix}{∅}_{1 , 3}^{pol 1} {I}_{L} & {0}_{L} \\ {0}_{L} & {∅}_{1 , 3}^{pol 2} {I}_{L}\end{matrix} ] & {\tilde{W}}_{2 , 1} {W}_{f}^{H}\end{matrix} \\ {W}_{1 , 2} {\tilde{W}}_{2 , 2} {W}_{f}^{H}\end{matrix} ]$$

For CJT between four TRPs, when first TRP group includes two co-located TRPs and second TRP group includes other two co-located TRPs, the following codebook structure may be used to derive and report PMI:

$$[ \begin{matrix}{W}_{1 , 1} {\tilde{W}}_{2 , 1} {W}_{f , 1}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f , 1}^{H}\end{matrix} \\ {W}_{1 , 2} {\tilde{W}}_{2 , 2} {W}_{f , 2}^{H} \\ \begin{matrix}{W}_{1 , 2} & [ \begin{matrix}{∅}_{2 , 2}^{pol 1} {I}_{L} & {0}_{L} \\ {0}_{L} & {∅}_{2 , 2}^{pol 2} {I}_{L}\end{matrix} ] & {\tilde{W}}_{2 , 2} {W}_{f , 2}^{H}\end{matrix}\end{matrix} ] or \qquad Equation 17.$$

$$[ \begin{matrix}{W}_{1 , 1} {\tilde{W}}_{2 , 1} {W}_{f}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f}^{H}\end{matrix} \\ {W}_{1 , 2} {\tilde{W}}_{2 , 2} {W}_{f}^{H} \\ \begin{matrix}{W}_{1 , 2} & [ \begin{matrix}{∅}_{2 , 2}^{pol 1} {I}_{L} & {0}_{L} \\ {0}_{L} & {∅}_{2 , 2}^{pol 2} {I}_{L}\end{matrix} ] & {\tilde{W}}_{2 , 1} {W}_{f}^{H}\end{matrix}\end{matrix} ]$$

For CJT between four TRPs, when first TRP group includes two co-located TRPs, a second TRP group includes a single TRP, and a third TRP group includes another single TRP, the following codebook structure may be used to derive and report the PMI:

$$[ \begin{matrix}{W}_{1 , 1} {\tilde{W}}_{2 , 1} {W}_{f , 1}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f , 1}^{H}\end{matrix} \\ {W}_{1 , 2} {\tilde{W}}_{2 , 2} {W}_{f , 2}^{H} \\ {W}_{1 , 3} {\tilde{W}}_{2 , 3} {W}_{f , 3}^{H}\end{matrix} ] or \qquad Equation 18.$$

$$[ \begin{matrix}{W}_{1 , 1} {\tilde{W}}_{2 , 1} {W}_{f}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f}^{H}\end{matrix} \\ {W}_{1 , 2} {\tilde{W}}_{2 , 2} {W}_{f}^{H} \\ {W}_{1 , 3} {\tilde{W}}_{2 , 3} {W}_{f}^{H}\end{matrix} ]$$

For CJT between three TRPs, when first TRP group includes two co-located TRPs and second TRP group includes a single TRP, the following codebook structure may be used to derive and report PMI:

$$[ \begin{matrix}{W}_{1 , 1} {\tilde{W}}_{2 , 1} {W}_{f , 1}^{H} \\ \begin{matrix}{W}_{1 , 1} & [ \begin{matrix}{∅}_{1 , 2}^{pol 1} {I}_{L} & {0}_{L} \\ {0}_{L} & {∅}_{1 , 2}^{pol 2} {I}_{L}\end{matrix} ] & {\tilde{W}}_{2 , 1} {W}_{f , 1}^{H}\end{matrix} \\ {W}_{1 , 2} {\tilde{W}}_{2 , 2} {W}_{f , 2}^{H}\end{matrix} ] or \qquad Equation 19.$$

$$[ \begin{matrix}{W}_{1 , 1} {\tilde{W}}_{2 , 1} {W}_{f}^{H} \\ \begin{matrix}{W}_{1 , 1} & [ \begin{matrix}{∅}_{1 , 2}^{pol 1} {I}_{L} & {0}_{L} \\ {0}_{L} & {∅}_{2}^{pol 2} {I}_{L}\end{matrix} ] & {\tilde{W}}_{2 , 1} {W}_{f}^{H}\end{matrix} \\ {W}_{1 , 2} {\tilde{W}}_{2 , 2} {W}_{f}^{H}\end{matrix} ]$$

In sum, for such instances, the precoding information on W₁ may be reported on a per TRP group basis. Information on frequency basis (W_{f}) may be derived on per TRP group (or a single frequency basis for all TRP) and coefficients \tilde{W}₂ may be derived and reported on a per TRP group basis. Additionally, per-POL co-phasing values may be derived and reported between different TRPs per TRP group.

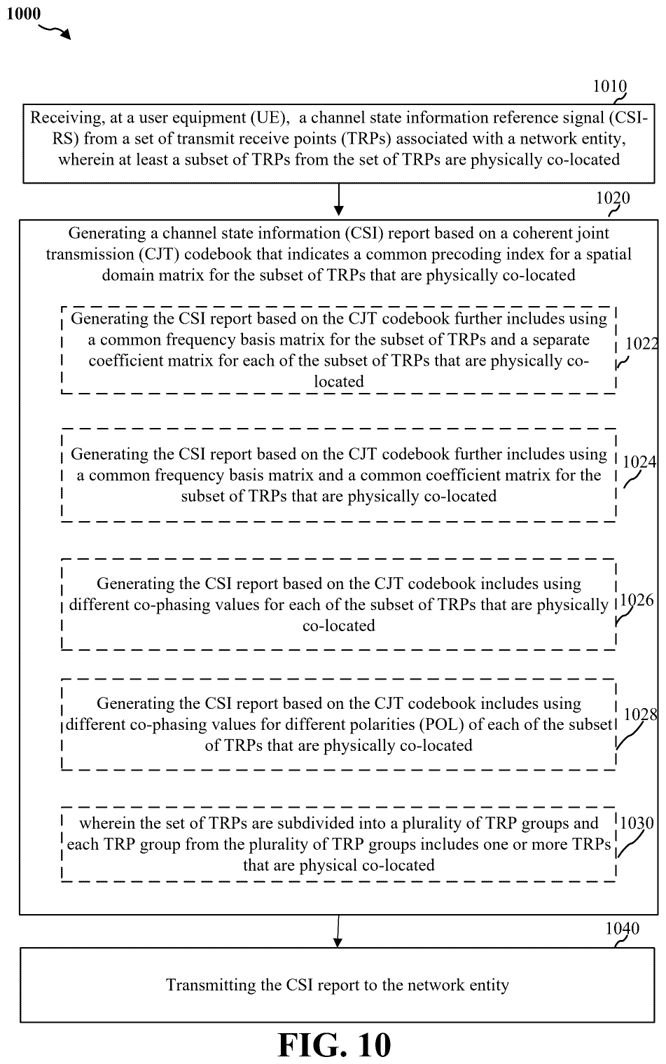

FIG. 10 is a flowchart of a method 1000 of wireless communication that may be performed by a UE (e.g., the UE 104, which may include the memory 360 and which may be the entire UE 104 or a component of the UE 104 such as the localized multi-TRP CSI reporting component 140, TX processor 368, the RX processor 356, and/or the controller/processor 359) for performing CSI reporting generations for localized TRPs. The method 1000 may be performed by the UE 104 including the localized multi-TRP CSI reporting component 140.

In block 1010, the method 1000 may include receiving, at a UE, a CSI-RS from a set of TRPs associated with a network entity, wherein at least a subset of TRPs from the set of TRPs may be physically co-located. In an aspect, for example, the UE 104, the Rx processor 356, the controller/processor 359, and/or the processor 1112 may execute the localized multi-TRP CSI reporting component 140 may perform the method 1010. Accordingly, the UE 104, the Rx processor 356, the controller/processor 359, and/or the processor 1112 executing the localized multi-TRP CSI reporting component 140 may provide means for receiving, at a UE, a CSI-RS from a set of TRPs associated with a network entity.

In block 1020, the method 1000 may include generating a channel state information (CSI) report based on a coherent joint transmission (CJT) codebook that indicates a common precoding index for a spatial domain matrix for the subset of TRPs that are physically co-located. In an aspect, for example, the UE 104, the controller/processor 359, and/or the processor 1112 may execute the localized multi-TRP CSI reporting component 140 and CSI report generation component 143 in conjunction with CJT codebook 142 may perform the method 1020. Accordingly, the UE 104, the controller/processor 359, and/or the processor 1112 may execute the localized multi-TRP CSI reporting component 140 and CSI report generation component 143 in conjunction with CJT codebook 142 may provide means for generating a CSI report based on a CJT codebook that indicates a common precoding index for a spatial domain matrix for the subset of TRPs that are physically co-located.

In sub-block 1022, the block 1020 for generating the CSI report based on the CJT codebook may further optionally include using a common frequency basis matrix for the subset of TRPs and a separate coefficient matrix for each of the subset of TRPs that are physically co-located.

In sub-block 1024, the block 1020 for generating the CSI report based on the CJT codebook may further optionally include using a common frequency basis matrix and a common coefficient matrix for the subset of TRPs that are physically co-located.

In sub-block 1026, the block 1020 for generating the CSI report based on the CJT codebook may optionally include using different co-phasing values for each of the subset of TRPs that are physically co-located.

In sub-block 1028, the block 1020 for generating the CSI report based on the CJT codebook may optionally include using different co-phasing values for different polarities (POL) of each of the subset of TRPs that are physically co-located.

In sub-block 1030, the block 1020 may include the method where the set of TRPs may be subdivided into a plurality of TRP groups and each TRP group from the plurality of TRP groups includes one or more TRPs that are physical co-located. In some examples, the UE may receive configuration information regarding the plurality of TRP groups. In some examples, the plurality of TRP groups may include a first TRP group comprising a plurality of TRPs and a second TRP group including at least one TRP. The first TRP group may include a first precoding index for spatial domain matrix that is common for all of the plurality of TRPs within the first TRP group, and the second TRP group may include a second precoding index for spatial domain matrix that is common for all TRPs within the second TRP group. But the first precoding index for spatial domain matrix and the second precoding index for spatial domain matrix may be different. In some examples, the set of TRPs for both the first TRP group and the second TRP group may include a different coefficient matrix.

In some examples, the first TRP group may have a first frequency basis matrix that is common for all of the plurality of TRPs within the first TRP group, and the second TRP group may have a frequency basis matrix that is common for all of the plurality of TRPs within the second TRP group, the first frequency basis matrix and the second frequency basis matrix may be different. Additionally or alternatively, generating the CSI report based on the CJT codebook may further include using a common frequency basis matrix for the subset of TRPs across the plurality of TRP groups. The first TRP group may have a first set of co-phasing values for each TRP within the first TRP group, and the second TRP group may have a second set of co-phasing values for each TRP within the second TRP group. Additionally, the plurality of TRP groups may have different polarities (POL) for the first TRP group and the second TRP group.

In block 1040, the method 1000 may include transmitting the CSI report to the network entity. In an aspect, for example, the UE 104, the Tx processor 368, the controller/processor 359, and/or the processor 1112 may execute the localized multi-TRP CSI reporting component 140 and/or the transmission component 144 to perform the steps of method 1040. Accordingly, the UE 104, the Tx processor 368, the controller/processor 359, and/or the processor 1112 executing the localized multi-TRP CSI reporting component 140 and/or the transmission component 144 may provide means for transmitting the CSI report to the network entity.

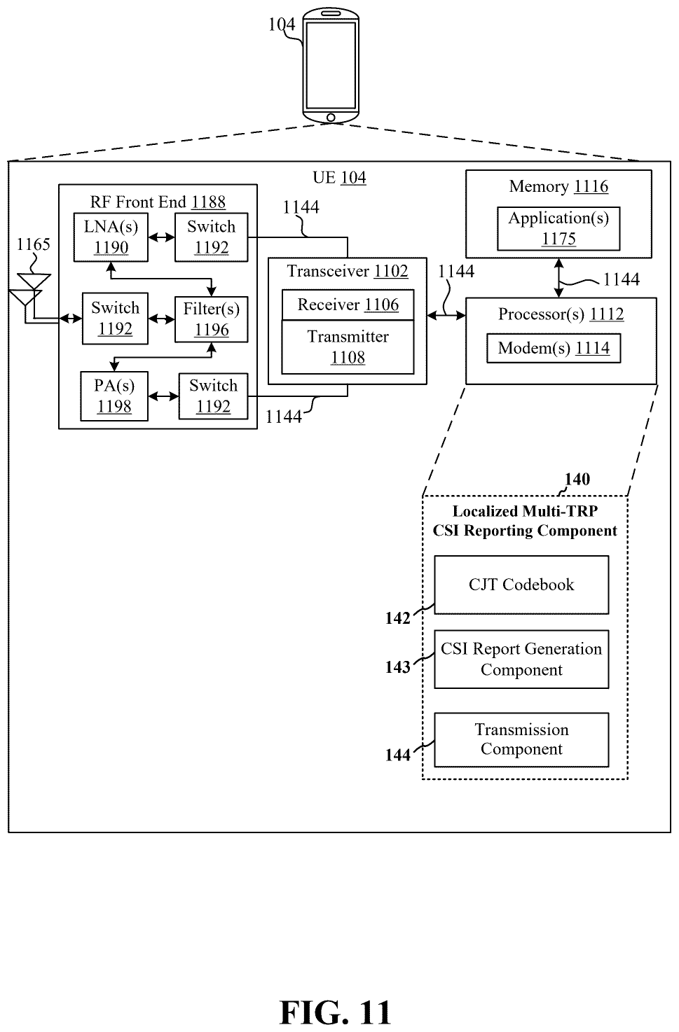

Referring to FIG. 11, one example of an implementation of UE 104 may include a variety of components, some of which have already been described above, but including components such as one or more processors 1112 and memory 1116 and transceiver 1102 in communication via one or more buses 1144, which may operate in conjunction with modem 1114, and localized multi-TRP CSI reporting component 140 to enable one or more of the functions described herein related to CSI reporting for multiple TSPs. Further, the one or more processors 1112, modem 1114, memory 1116, transceiver 1102, RF front end 1188 and one or more antennas 1165 may be configured to support voice and/or data calls (simultaneously or non-simultaneously) in one or more radio access technologies. The antennas 1165 may include one or more antennas, antenna elements, and/or antenna arrays.

In an aspect, the one or more processors 1112 may include a modem 1114 that uses one or more modem processors. The various functions related to localized multi-TRP CSI reporting component 140 may be included in modem 1114 and/or processors 1112 and, in an aspect, may be executed by a single processor, while in other aspects, different ones of the functions may be executed by a combination of two or more different processors. For example, in an aspect, the one or more processors 1112 may include any one or any combination of a modem processor, or a baseband processor, or a digital signal processor, or a transmit processor, or a receiver processor, or a transceiver processor associated with transceiver 1102. In other aspects, some of the features of the one or more processors 1112 and/or modem 1114 associated with localized multi-TRP CSI reporting component 140 may be performed by transceiver 1102.

Also, memory 1116 may be configured to store data used herein and/or local versions of applications 1175, localized multi-TRP CSI reporting component 140 and/or one or more of subcomponents thereof being executed by at least one processor 1112. Memory 1116 may include any type of computer-readable medium usable by a computer or at least one processor 1112, such as random access memory (RAM), read only memory (ROM), tapes, magnetic discs, optical discs, volatile memory, non-volatile memory, and any combination thereof. In an aspect, for example, memory 1116 may be a non-transitory computer-readable storage medium that stores one or more computer-executable codes defining localized multi-TRP CSI reporting component 140 and/or one or more of subcomponents thereof, and/or data associated therewith, when UE 104 is operating at least one processor 1112 to execute localized multi-TRP CSI reporting component 140 and/or one or more subcomponents thereof.

Transceiver 1102 may include at least one receiver 1106 and at least one transmitter 1108. Receiver 1106 may include hardware, firmware, and/or software code executable by a processor for receiving data, the code comprising instructions and being stored in a memory (e.g., computer-readable medium). Receiver 1106 may be, for example, a radio frequency (RF) receiver. In an aspect, receiver 1106 may receive signals transmitted by at least one base station 102. Additionally, receiver 1106 may process such received signals, and also may obtain measurements of the signals, such as, but not limited to, Ec/Io, SNR, RSRP, RSSI, etc. Transmitter 1108 may include hardware, firmware, and/or software code executable by a processor for transmitting data, the code comprising instructions and being stored in a memory (e.g., computer-readable medium). A suitable example of transmitter 1108 may including, but is not limited to, an RF transmitter.

Moreover, in an aspect, UE 104 may include RF front end 1188, which may operate in communication with one or more antennas 1165 and transceiver 1102 for receiving and transmitting radio transmissions, for example, wireless communications transmitted by at least one base station 102 or wireless transmissions transmitted by UE 104. RF front end 1188 may be connected to one or more antennas 1165 and may include one or more low-noise amplifiers (LNAs) 1190, one or more switches 1192, one or more power amplifiers (PAS) 1198, and one or more filters 1196 for transmitting and receiving RF signals.

In an aspect, LNA 1190 may amplify a received signal at a desired output level. In an aspect, each LNA 1190 may have a specified minimum and maximum gain values. In an aspect, RF front end 1188 may use one or more switches 1192 to select a particular LNA 1190 and its specified gain value based on a desired gain value for a particular application.

Further, for example, one or more PA(s) 1198 may be used by RF front end 1188 to amplify a signal for an RF output at a desired output power level. In an aspect, each PA 1198 may have specified minimum and maximum gain values. In an aspect, RF front end 1188 may use one or more switches 1192 to select a particular PA 1198 and its specified gain value based on a desired gain value for a particular application.

Also, for example, one or more filters 1196 may be used by RF front end 1188 to filter a received signal to obtain an input RF signal. Similarly, in an aspect, for example, a respective filter 1196 may be used to filter an output from a respective PA 1198 to produce an output signal for transmission. In an aspect, each filter 1196 may be connected to a specific LNA 1190 and/or PA 1198. In an aspect, RF front end 1188 may use one or more switches 1192 to select a transmit or receive path using a specified filter 1196, LNA 1190, and/or PA 1198, based on a configuration as specified by transceiver 1102 and/or processor 1112.

As such, transceiver 1102 may be configured to transmit and receive wireless signals through one or more antennas 1165 via RF front end 1188. In an aspect, transceiver 1102 may be tuned to operate at specified frequencies such that UE 104 can communicate with, for example, one or more base stations 102 or one or more cells associated with one or more base stations 102. In an aspect, for example, modem 1114 may configure transceiver 1102 to operate at a specified frequency and power level based on the UE configuration of the UE 104 and the communication protocol used by modem 1114.

In an aspect, modem 1114 may be a multiband-multimode modem, which can process digital data and communicate with transceiver 1102 such that the digital data is sent and received using transceiver 1102. In an aspect, modem 1114 may be multiband and be configured to support multiple frequency bands for a specific communications protocol. In an aspect, modem 1114 may be multimode and be configured to support multiple operating networks and communications protocols. In an aspect, modem 1114 may control one or more components of UE 104 (e.g., RF front end 1188, transceiver 1102) to enable transmission and/or reception of signals from the network based on a specified modem configuration. In an aspect, the modem configuration may be based on the mode of the modem and the frequency band in use. In another aspect, the modem configuration may be based on UE configuration information associated with UE 104 as provided by the network during cell selection and/or cell reselection.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

### SOME FURTHER EXAMPLE CLAUSES

Implementation examples are described in the following numbered clauses:

1. A method for wireless communications, comprising:
receiving, at a user equipment (UE), a channel state information reference signal (CSI-RS) from a set of transmit receive points (TRPs) associated with a network entity, wherein at least a subset of TRPs from the set of TRPs are physically co-located;
generating a channel state information (CSI) report based on a coherent joint transmission (CJT) codebook that indicates a common precoding index for a spatial domain matrix for the subset of TRPs that are physically co-located; and transmitting the CSI report to the network entity.

2. The method of clause 1, wherein generating the CSI report based on the CJT codebook further includes using a common frequency basis matrix for the subset of TRPs and a separate coefficient matrix for each of the subset of TRPs that are physically co-located.

3. The method of clause 1 or 2, wherein generating the CSI report based on the CJT codebook further includes using a common frequency basis matrix and a common coefficient matrix for the subset of TRPs that are physically co-located.

4. The method of any of the preceding clauses, wherein generating the CSI report based on the CJT codebook includes using different co-phasing values for each of the subset of TRPs that are physically co-located.

5. The method of any of the preceding clauses, wherein generating the CSI report based on the CJT codebook includes using different co-phasing values for different polarities (POL) of each of the subset of TRPs that are physically co-located.

6. The method of any of the preceding clauses, wherein the set of TRPs are subdivided into a plurality of TRP groups and each TRP group from the plurality of TRP groups includes one or more TRPs that are physical co-located.

7. The method of any of the preceding clauses, further comprising:
receiving configuration information regarding the plurality of TRP groups.

8 The method of any of the preceding clauses, wherein the plurality of TRP groups includes a first TRP group comprising a plurality of TRPs and a second TRP group including at least one TRP,
wherein the first TRP group has a first precoding index for spatial domain matrix that is common for all of the plurality of TRPs within the first TRP group, and
wherein the second TRP group has a second precoding index for spatial domain matrix that is common for all TRPs within the second TRP group, the first precoding index for spatial domain matrix and the second precoding index for spatial domain matrix are different.

9. The method of any of the preceding clauses, wherein the set of TRPs for both the first TRP group and the second TRP group include a different coefficient matrix.

10. The method of any of the preceding clauses, wherein the first TRP group has a first frequency basis matrix that is common for all of the plurality of TRPs within the first TRP group, and
wherein the second TRP group has a second frequency basis matrix that is common for all of the plurality of TRPs within the second TRP group, the first frequency basis matrix and the second frequency basis matrix are different.

11. The method of any of the preceding clauses, wherein generating the CSI report based on the CJT codebook further includes using a common frequency basis matrix for the subset of TRPs across the plurality of TRP groups.

12. The method of any of the preceding clauses, wherein the first TRP group has a first set of co-phasing values for each TRP within the first TRP group, and
wherein the second TRP group has a second set of co-phasing values for each TRP within the second TRP group.

13. The method of any of the preceding clauses, wherein the plurality of TRP groups have different polarities (POL) for the first TRP group and the second TRP group.

14. An apparatus for wireless communication, comprising:
a memory storing computer-executable instructions; and
a processor, communicatively coupled with the memory and configured to execute the instructions to:
   receive, at a user equipment (UE), a channel state information reference signal (CSI-RS) from a set of transmit receive points (TRPs) associated with a network entity, wherein at least a subset of TRPs from the set of TRPs are physically co-located;
   generate a channel state information (CSI) report based on a coherent joint transmission (CJT) codebook that indicates a common precoding index for a spatial domain matrix for the subset of TRPs that are physically co-located; and
   transmit the CSI report to the network entity.

15. The apparatus of clause 14, wherein the processor configured to generate the CSI report based on the CJT codebook is further configured to use a common frequency basis matrix for the subset of TRPs and a separate coefficient matrix for each of the subset of TRPs that are physically co-located.

16. The apparatus of clauses 14 or 15, wherein the processor configured to generate the CSI report based on the CJT codebook is further configured to use a common frequency basis matrix and a common coefficient matrix for the subset of TRPs that are physically co-located.

17. The apparatus of clauses 14-16, wherein the processor configured to generate the CSI report based on the CJT codebook is further configured to use different co-phasing values for each of the subset of TRPs that are physically co-located.

18. The apparatus of clauses 14-17, wherein the processor configured to generate the CSI report based on the CJT codebook is further configured to use different co-phasing values for different polarities (POL) of each of the subset of TRPs that are physically co-located.

19. The apparatus of any of the preceding clauses, wherein the set of TRPs are subdivided into a plurality of TRP groups and each TRP group from the plurality of TRP groups includes one or more TRPs that are physical co-located.

20. The apparatus of any of the preceding clauses, wherein the processor is further configured to:
receive configuration information regarding the plurality of TRP groups.

21. The apparatus of any of the preceding clauses, wherein the plurality of TRP groups includes a first TRP group comprising a plurality of TRPs and a second TRP group including at least one TRP,
wherein the first TRP group has a first precoding index for spatial domain matrix that is common for all of the plurality of TRPs within the first TRP group, and
wherein the second TRP group has a second precoding index for spatial domain matrix that is common for all TRPs within the second TRP group, the first precoding index for spatial domain matrix and the second precoding index for spatial domain matrix are different.

22. The apparatus of any of the preceding clauses, wherein the set of TRPs for both the first TRP group and the second TRP group include a different coefficient matrix.

23. The apparatus of any of the preceding clauses, wherein the first TRP group has a first frequency basis matrix that is common for all of the plurality of TRPs within the first TRP group, and
wherein the second TRP group has a second frequency basis matrix that is common for all of the plurality of TRPs within the second TRP group, the first frequency basis matrix and the second frequency basis matrix are different.

24. The apparatus of any of the preceding clauses, wherein the processor configured to generate the CSI report based on the CJT codebook is further configured to use a common frequency basis matrix for the subset of TRPs across the plurality of TRP groups.

25. The apparatus of any of the preceding clauses, wherein the first TRP group has a first set of co-phasing values for each TRP within the first TRP group, and
wherein the second TRP group has a second set of co-phasing values for each TRP within the second TRP group.

26 The apparatus of any of the preceding clauses, wherein the plurality of TRP groups have different polarities (POL) for the first TRP group and the second TRP group.

27 An apparatus for wireless communication, comprising:
means for receiving, at a user equipment (UE), a channel state information reference signal (CSI-RS) from a set of transmit receive points (TRPs) associated with a network entity, wherein at least a subset of TRPs from the set of TRPs are physically co-located;
means for generating a channel state information (CSI) report based on a coherent joint transmission (CJT) codebook that indicates a common precoding index for a spatial domain matrix for the subset of TRPs that are physically co-located; and means for transmitting the CSI report to the network entity.

28. A non-transitory computer-readable medium storing computer executable code, the code when executed by a processor causes the processor to:
receive, at a user equipment (UE), a channel state information reference signal (CSI-RS) from a set of transmit receive points (TRPs) associated with a network entity, wherein at least a subset of TRPs from the set of TRPs are physically co-located;
generate a channel state information (CSI) report based on a coherent joint transmission (CJT) codebook that indicates a common precoding index for a spatial domain matrix for the subset of TRPs that are physically co-located; and
transmit the CSI report to the network entity.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method for wireless communications, comprising:
receiving, at a user equipment (UE), a channel state information reference signal (CSI-RS) from a set of transmit receive points (TRPs) associated with a network entity, wherein at least a subset of TRPs from the set of TRPs are physically co-located;
generating a channel state information (CSI) report based on a coherent joint transmission (CJT) codebook that indicates a common precoding index for a spatial domain matrix for the subset of TRPs that are physically co-located; and
transmitting the CSI report to the network entity.

2. The method of claim 1, wherein generating the CSI report based on the CJT codebook further includes using a common frequency basis matrix for the subset of TRPs and a separate coefficient matrix for each of the subset of TRPs that are physically co-located.

3. The method of claim 1, wherein generating the CSI report based on the CJT codebook further includes using a common frequency basis matrix and a common coefficient matrix for the subset of TRPs that are physically co-located.

4. The method of claim 3, wherein generating the CSI report based on the CJT codebook includes using different co-phasing values for each of the subset of TRPs that are physically co-located.

5. The method of claim 3, wherein generating the CSI report based on the CJT codebook includes using different co-phasing values for different polarities (POL) of each of the subset of TRPs that are physically co-located.

6. The method of claim 3, wherein the set of TRPs are subdivided into a plurality of TRP groups and each TRP group from the plurality of TRP groups includes one or more TRPs that are physically co-located.

7. The method of claim 6, further comprising:
receiving configuration information regarding the plurality of TRP groups.

8. The method of claim 6, wherein the plurality of TRP groups includes a first TRP group comprising a plurality of TRPs and a second TRP group including at least one TRP,
wherein the first TRP group has a first precoding index for spatial domain matrix that is common for all of the plurality of TRPs within the first TRP group, and
wherein the second TRP group has a second precoding index for spatial domain matrix that is common for all TRPs within the second TRP group, the first precoding index for spatial domain matrix and the second precoding index for spatial domain matrix are different.

9. The method of claim 8, wherein the set of TRPs for both the first TRP group and the second TRP group include a different coefficient matrix.

10. The method of claim 8, wherein the first TRP group has a first frequency basis matrix that is common for all of the plurality of TRPs within the first TRP group, and
wherein the second TRP group has a second frequency basis matrix that is common for all of the plurality of TRPs within the second TRP group, the first frequency basis matrix and the second frequency basis matrix are different.

11. The method of claim 8, wherein generating the CSI report based on the CJT codebook further includes using the common frequency basis matrix for the subset of TRPs across the plurality of TRP groups.

12. The method of claim 8, wherein the first TRP group has a first set of co-phasing values for each TRP within the first TRP group, and
wherein the second TRP group has a second set of co-phasing values for each TRP within the second TRP group.

13. The method of claim 8, wherein the plurality of TRP groups have different polarities (POL) for the first TRP group and the second TRP group.

14. An apparatus for wireless communication, comprising:
a memory storing computer-executable instructions; and
a processor, communicatively coupled with the memory and configured to execute the instructions to:
receive, at a user equipment (UE), a channel state information reference signal (CSI-RS) from a set of transmit receive points (TRPs) associated with a network entity, wherein at least a subset of TRPs from the set of TRPs are physically co-located;
generate a channel state information (CSI) report based on a coherent joint transmission (CJT) codebook that indicates a common precoding index for a spatial domain matrix for the subset of TRPs that are physically co-located; and
transmit the CSI report to the network entity.

15. The apparatus of claim 14, wherein the processor configured to generate the CSI report based on the CJT codebook is further configured to use a common frequency basis matrix for the subset of TRPs and a separate coefficient matrix for each of the subset of TRPs that are physically co-located.

16. The apparatus of claim 14, wherein the processor configured to generate the CSI report based on the CJT codebook is further configured to use a common frequency basis matrix and a common coefficient matrix for the subset of TRPs that are physically co-located.

17. The apparatus of claim 16, wherein the processor configured to generate the CSI report based on the CJT codebook is further configured to use different co-phasing values for each of the subset of TRPs that are physically co-located.

18. The apparatus of claim 16, wherein the processor configured to generate the CSI report based on the CJT codebook is further configured to use different co-phasing values for different polarities (POL) of each of the subset of TRPs that are physically co-located.

19. The apparatus of claim 16, wherein the set of TRPs are subdivided into a plurality of TRP groups and each TRP group from the plurality of TRP groups includes one or more TRPs that are physically co-located.

20.-26. (canceled)

27. An apparatus for wireless communication, comprising:
means for receiving, at a user equipment (UE), a channel state information reference signal (CSI-RS) from a set of transmit receive points (TRPs) associated with a network entity, wherein at least a subset of TRPs from the set of TRPs are physically co-located;
means for generating a channel state information (CSI) report based on a coherent joint transmission (CJT) codebook that indicates a common precoding index for a spatial domain matrix for the subset of TRPs that are physically co-located; and
means for transmitting the CSI report to the network entity.

28. (canceled)
